(19) United States
(12) Patent Application Publication
(10) Pub. No.: US 2025/0178642 A1
(43) Pub. Date: Jun. 5, 2025

(54) METHODS AND SYSTEMS FOR OBSTACLE REPRESENTATION

(71) Applicant: Motional AD LLC, Boston, MA (US)

(72) Inventors: Apoorv Shrivastava, Los Angeles, CA (US); Lixun LIN, Singapore (SG); Hans ANDERSEN, Singapore (SG); Zhi Jie CHUA, Singapore (SG); Allen TANG, Millbrae, CA (US)

(21) Appl. No.: 19/047,385

(22) Filed: Feb. 6, 2025

Related U.S. Application Data
(63) Continuation of application No. PCT/US2023/029774, filed on Aug. 8, 2023.
(60) Provisional application No. 63/396,233, filed on Aug. 9, 2022.

(51) Int. Cl. B60W 60/00

(52) U.S. Cl. CPC B60W 60/0027; B60W 2554/402; B60W 2554/80

(57) ABSTRACT

Provided are methods for obstacle representation, which can include obtaining sensor data, determining a dynamic associated with an agent, generating obstacle data, and generating constraints based on obstacle data. Some methods described also include providing data to cause operation of an autonomous vehicle. Systems and computer program products are also provided.

This application is a continuation of International Patent Application No. PCT/US2023/029774, filed on Aug. 8, 2023, entitled “METHODS AND SYSTEMS FOR OBSTACLE REPRESENTATION” which claims the priority benefit of U.S. Provisional Application No. 63/396,233, entitled “METHODS AND SYSTEMS FOR OBSTACLE REPRESENTATION”, filed Aug. 9, 2022. Each of the above-referenced applications is hereby incorporated herein by reference in its entirety.

### BRIEF DESCRIPTION OF THE FIGURES

FIG. 1 is an example environment in which a vehicle including one or more components of an autonomous system can be implemented;

FIG. 2 is a diagram of one or more example systems of a vehicle including an autonomous system;

FIG. 3 is a diagram of components of one or more example devices and/or one or more example systems of FIGS. 1 and 2;

FIG. 4 is a diagram of certain components of an example autonomous system;

FIG. 5 is a diagram of an example implementation of a process for obstacle representation;

FIGS. 6A-6B are diagrams of an example implementation of a process for obstacle representation;

FIG. 7 is a diagram illustrating an example projection of an obstacle according to one or more embodiments of this disclosure;

FIGS. 8A-8C are diagrams illustrating example generations of station constraints according to one or more embodiments of this disclosure;

FIG. 9 is a diagram illustrating an example generation of lateral constraints according to one or more embodiments of this disclosure; and

FIG. 10 is a flowchart of an example process for obstacle representation.

FIG. 11 illustrates an example station-lateral constraint and station time constraint analysis based on sensor data associated with an agent that is moving toward the road along which the AV is moving.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

“At least one,” and “one or more” includes a function being performed by one element, a function being performed by more than one element, e.g., in a distributed fashion, several functions being performed by one element, several functions being performed by several elements, or any combination of the above.”

Some embodiments of the present disclosure are described herein in connection with a threshold. As described herein, satisfying, such as meeting, a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

A vehicle may encounter various types of obstacles, e.g., other vehicles, pedestrians, infrastructure. Planning a route for an autonomous vehicle is resource intensive task, that requires some optimization to provide real-time planning.

In some aspects and/or embodiments, systems, methods, and computer program products described herein include and/or implement obtaining, using at least one processor, sensor data indicative of an agent in an environment where an autonomous vehicle is configured to operate along a first trajectory, determining, using the at least one processor, a dynamic associated with the agent, generating, using the at least one processor, based on the dynamic track, obstacle data associated with the agent, wherein the obstacle data is indicative of the agent being an obstacle along a first trajectory (e.g., a baseline) of the autonomous vehicle, determining, using the at least one processor, based on the obstacle data, a station constraint and a lateral constraint to apply to trajectories, generating, using the at least one processor, based on the station constraint and the lateral constraint, a second trajectory of the autonomous vehicle, and providing, using the at least one processor, data associated with the second trajectory, the data associated with the second trajectory configured to cause operation of the autonomous vehicle along the second trajectory.

By virtue of the implementation of systems, methods, and computer program products described herein, techniques for obstacle representation advantageously provide for a more efficient generation of constraints for dynamic tracks in a route planning of an autonomous vehicle while providing safety. The disclosed techniques can simplify the generation of Station Lateral and Time (SLT) constraints, and thereby improve computational efficiency while improving accuracy. The disclosed techniques further allow for the modelling longitudinal behavior (e.g., speed, station) and lateral behavior of the autonomous vehicle (e.g., steering) using the SLT constraints. By virtue of implementation, these techniques can provide a faster provision of trajectories when encountering an agent.

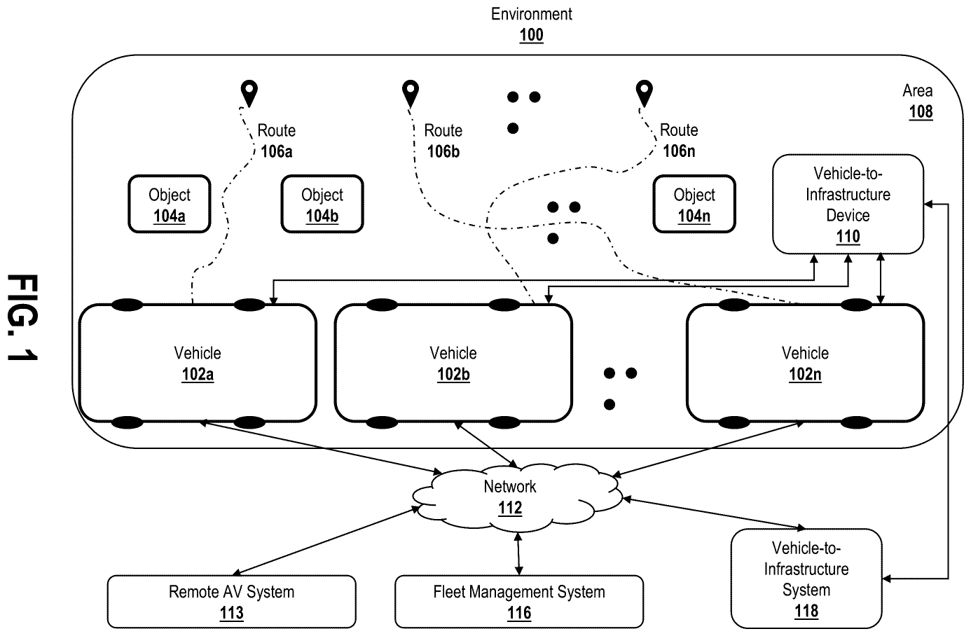

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

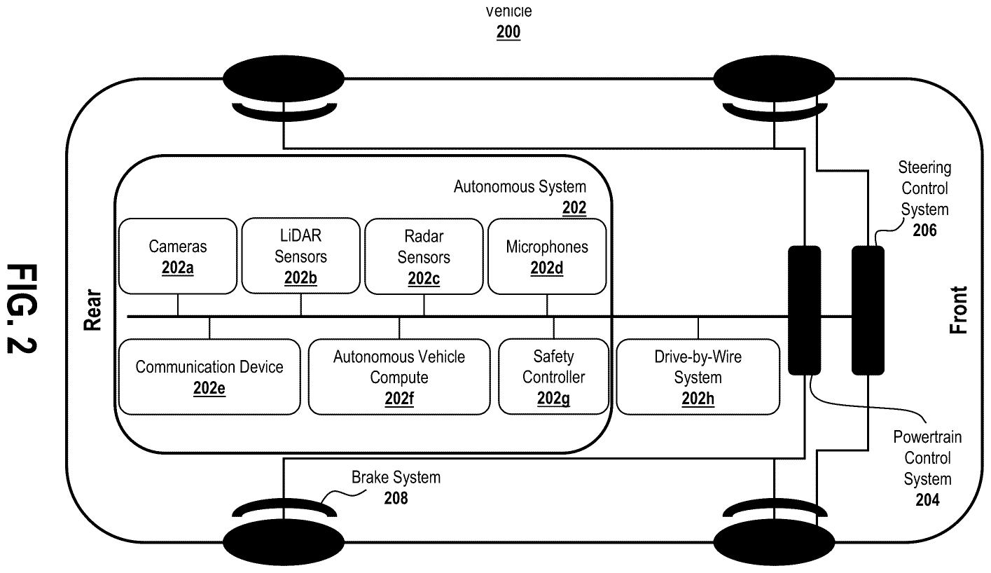

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high-level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

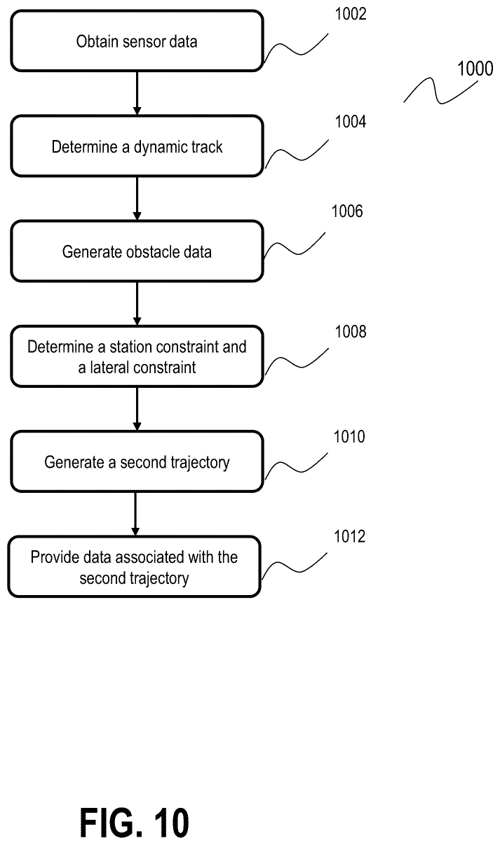

In some embodiments, device 300 is configured to execute software instructions of one or more steps of the disclosed method, as illustrated in FIG. 10.

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

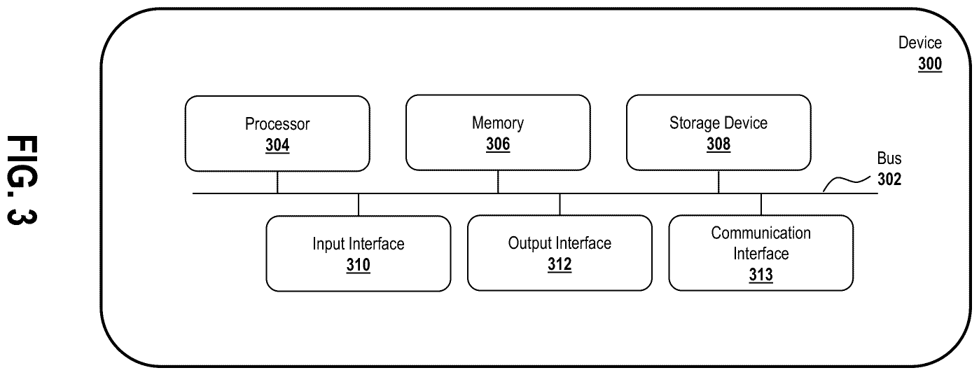

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 make longitudinal vehicle motion, such as to start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate. In other words, steering control system 206 causes activities necessary for the regulation of the y-axis component of vehicle motion.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112). In some embodiments, one or more devices of vehicles 102 (e.g., one or more devices of a system of vehicles 102 such as at least one device of remote AV system 114, fleet management system 116, and V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

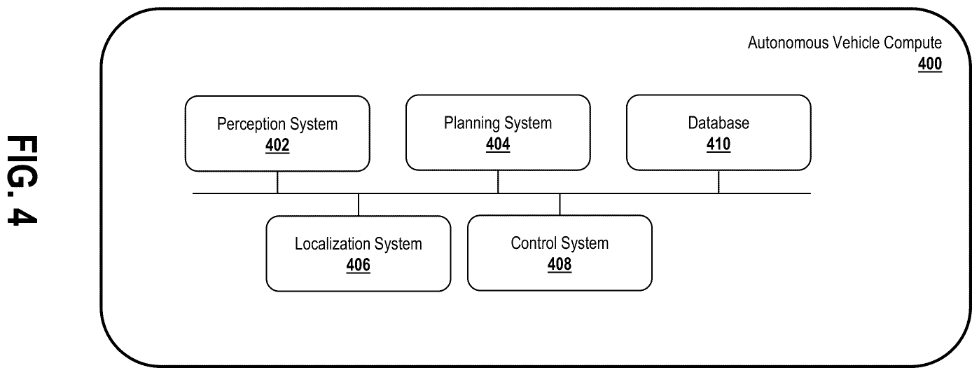

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

The present disclosure provides techniques that determine, for a route over a time horizon, dynamic tracks of obstacles (such as vehicles or pedestrians) as a function of time. In some examples, the dynamic tracks are provided associated with corresponding predictions. A dynamic track of an obstacle provides for example data that enables tracking the obstacle (e.g., an agent) per time unit, and predicting, where the obstacle may be based on previous time frame. For example, dynamic tracks are representative of one or more obstacle projections in 2D space (station over time for station constraints and lateral clearance over station for spatial constraints). The dynamic tracks are for example used to determine where the AV can be along the route plan (e.g., based on the station constraints) and how much space it has to its sides (e.g., based on the lateral constraints) at a specific time within the time horizon.

The present disclosure relates to systems, methods, and computer program products that provide for determination of a dynamic track (with predictions) of an agent, such as a vehicle or a pedestrian, as a function of time. The dynamic track can then be used to generate obstacle data which indicates the agent as being an obstacle along the autonomous vehicle trajectory. The obstacle data is then used for determining Station Lateral and Time (SLT) constraints for autonomous vehicle route planning. The SLT constraints can be used to generate a trajectory for the autonomous vehicle by determining a homotopy based on the SLT constraints. The SLT constraints can be considered an obstacle projection in 2D space. The autonomous vehicle can use the obstacles to generate constraints that can be queried, representing where the autonomous vehicle can be along the route plan (station) and how much space it has to its sides (lateral) at a specific time within a time horizon.

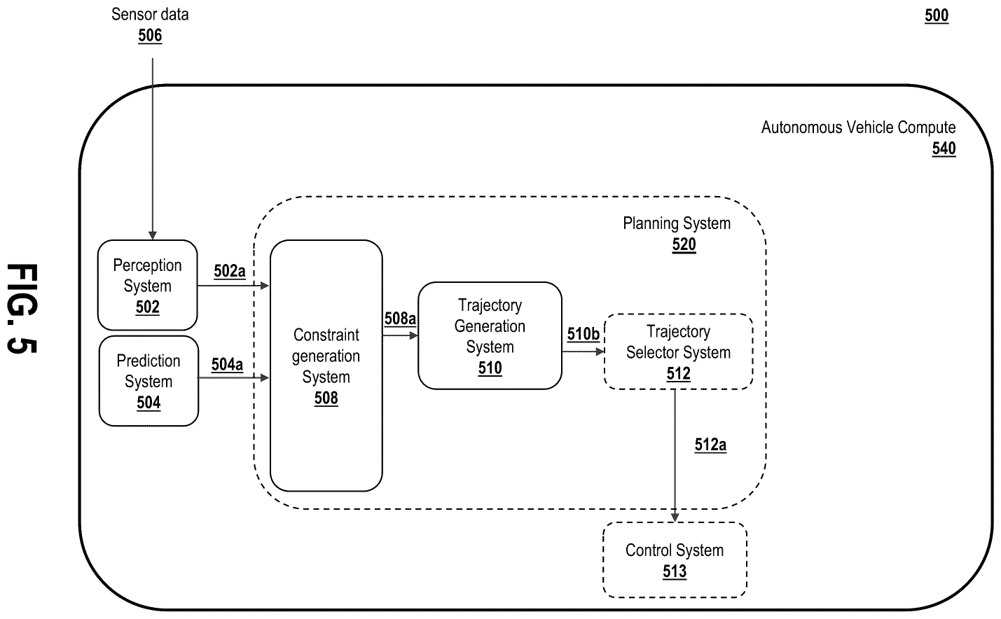

Referring now to FIG. 5, illustrated is a diagram of a system 500 for obstacle representation. In some embodiments, system 500 is connected with and/or incorporated in a vehicle (e.g., an autonomous vehicle that is the same as, or similar to, vehicle 200 of FIG. 2). In one or more embodiments or examples, system 500 is in communication with and/or a part of an AV (e.g., such as Autonomous System 202 illustrated in FIG. 2, device 300 of FIG. 3), an AV system, an AV compute 540 (such as AV compute 202f of FIG. 2 and/or AV compute 400 of FIG. 4), a remote AV system (such as remote AV system 114 of FIG. 1), a fleet management system (such as fleet management system 116 of FIG. 1), and a V2I system (such as V2I system 118 of FIG. 1). The system 500 can be for operating a vehicle. In one or more examples, the system 500 is for operating an autonomous vehicle.

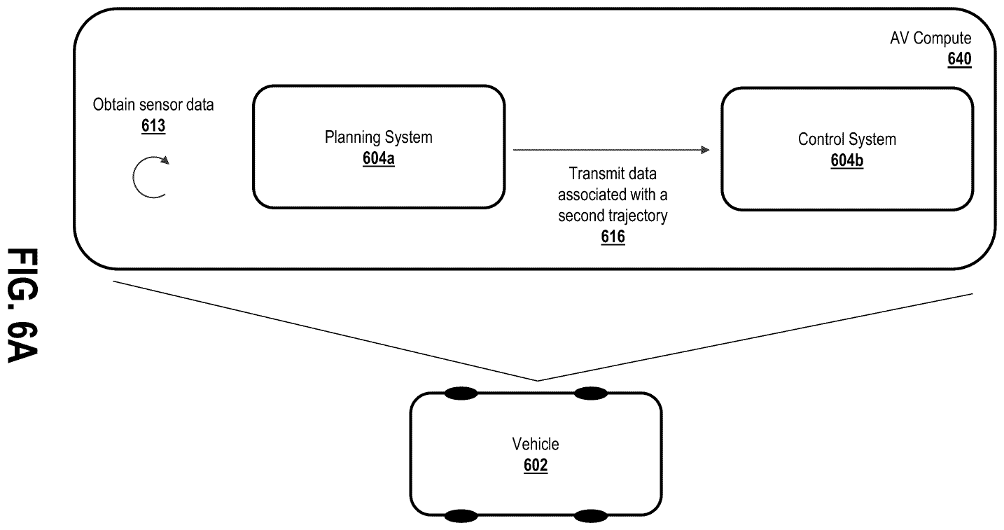

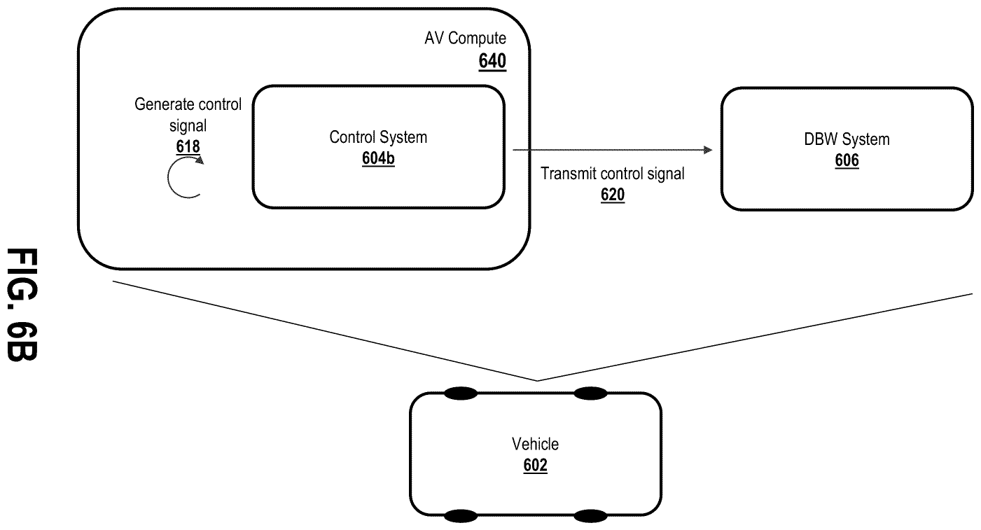

In one or more embodiments or examples, the system 500 is in communication with one or more of: a device (such as device 300 of FIG. 3). In one or more embodiments or examples, the system 500 includes one or more of: a planning system 504 (e.g., planning system 404, 604a of FIGS. 4 and 6, respectively), a perception system 502 (e.g., perception system 402 of FIG. 4), a prediction system 504, and a control system 508 (e.g., control system 408, 604b of FIGS. 4 and 6, respectively). In one or more embodiments or examples, system 500 includes a constraint generation system 508, a trajectory generation system 510, and optionally a trajectory selector system 512.

Disclosed herein is a system 500. In one or more examples or embodiments, the system 500 includes at least one processor. In one or more examples or embodiments, the system 500 includes at least one memory storing instructions that, when executed by the at least one processor, cause the at least one processor to perform operations. In one or more examples or embodiments, the operations include obtaining sensor data 506 indicative of an agent in an environment where an autonomous vehicle is configured to operate along a first trajectory. In one or more examples or embodiments, the operations include determining a dynamic track associated with the agent. In one or more examples or embodiments, the operations include generating, based on the dynamic track, obstacle data associated with the agent. In one or more examples or embodiments, the obstacle data is indicative of the agent being an obstacle along a first trajectory of the autonomous vehicle. In one or more examples or embodiments, the operations include determining, based on the obstacle data, a station constraint and a lateral constraint to apply to trajectories. In one or more examples or embodiments, the operations include generating, based on the station constraint and the lateral constraint, a second trajectory of the autonomous vehicle. In one or more examples or embodiments, the operations include providing data associated with the second trajectory, the data associated with the second trajectory configured to cause operation of the autonomous vehicle along the second trajectory.

In other words, the system 500 is configured to use sensor data 506 to detect agents surrounding the autonomous vehicle and predict a path that the agent would take (e.g., the dynamic track). Using this predicted dynamic path, the system 500 can provide a trajectory configured to cause control operation of the autonomous vehicle, including through the use of constraints, to avoid a detrimental interaction with the agent. The disclosed system is configured to greatly improve computational efficiency for avoiding agents in the field, especially having both the agent and/or the autonomous vehicle potentially taking a plurality of paths.

In some of the conventional methods, upon determining a path for an AV, a system samples data at fixed distances along the path and imposes speed and spatial constraints on some or all obstacles encountered. In some cases, this approach can be a complex process and may be usable for a single path. There exists a need for a more efficient method for generating constraints to avoid collision or interaction with dynamic agents near a baseline path. The disclosed systems and methods can enable the determination of multiple safe trajectories and corresponding route plans based on a projection of the agents in station-lateral-time domain that significantly reduces the computational cost of such determinations. Accordingly, in certain examples, the disclosure is configured to generate obstacle data from dynamic tracks (e.g., predicted dynamic tracks of agents), such as by compiling the information for each dynamic track and generating the station and lateral constraints.

In one or more examples or embodiments, the system 500 obtains sensor data 506 (e.g., for detection of the environment around the system and/or the autonomous vehicle). For example, a perception system (such as, similar to perception system 402 of FIG. 4) of the system can be used for obtaining the sensor data 506. The sensor data 506 can be one or more of: radar sensor data, non-radar sensor data, camera sensor data, image sensor data, audio sensor, and LIDAR sensor data. The particular type of sensor data is not limiting. The sensor data 506 can be indicative of an environment around an autonomous vehicle. For example, sensor data 506 can be indicative of an object, and/or a plurality of objects, in the environment around an autonomous vehicle. The objects can include agents in the environment. For example, the agent is an object that can have (e.g., is capable of) dynamic movement. Agents are, for example, vehicles, pedestrians, bicyclists, etc. The sensor data 506 can be indicative of one or more agents, such as one or more of: a vehicle, pedestrian, and bicyclist.

In one or more examples or embodiments, the sensor is one or more sensors, such as an onboard sensor. The sensor can be associated with the autonomous vehicle. An autonomous vehicle, for example, includes one or more sensors that are configured to monitor an environment where the autonomous vehicle operates, such as via the sensor, through sensor data 506. For example, monitoring provides sensor data 506 indicative of what is happening in the environment around the autonomous vehicle, such as for determining trajectories of the autonomous vehicle. The sensor can include one or more of the sensors illustrated in FIG. 2. The sensor can be one or more of: a radar sensor, a camera sensor, a microphone, an infrared sensor, an image sensor, and a LIDAR sensor. In one or more example systems, the sensor can be selected from the group consisting of a radar sensor, a camera sensor, and a LIDAR sensor.

While the system 500 is obtaining the sensor data 506 indicative of the agent in the environment, in one or more examples or embodiments, the autonomous vehicle is configured to operate along a first trajectory in the environment. The autonomous vehicle can be actively operating along the first trajectory while obtaining sensor data 506. The autonomous vehicle, in some examples, is configured to operate along the first trajectory (e.g., not actively operating along the first trajectory but capable of/prepared to). The system 500, for example, provides data associated with the first trajectory to cause operation of the autonomous vehicle along the first trajectory. The first trajectory can be a trajectory as discussed with respect to FIG. 1.

In some examples, the sensor data 506 is indicative of an agent in the environment. In one or more examples or embodiments, the system 500 is configured to determine a dynamic track 504a associated with the agent. For example, the prediction system 504 of the system 500 can be configured to determine the dynamic track 504a. System 500 can be configured to determine a plurality of dynamic tracks, each dynamic track 504a of the plurality of dynamic tracks associated with one of a plurality of agents. The dynamic track, for example, is a prediction (e.g., estimation, projection) of a trajectory and/or position of the agent as a function of time. In other words, the dynamic track is indicative of where the agent is moving over a particular time period, e.g., over a future time period. In one or more examples or embodiments, the dynamic track is configured to keep track of the agent (e.g., agent trajectory) over time. For example, the dynamic track is representative of the position of the agent over time. In one or more examples or embodiments, the dynamic track is a prediction of a trajectory of the agent as a function of distance. For example, system 500 is configured to determine the dynamic track 504a by predicting where the agent moves, such as based on the velocity of the agent and the location of the agent in one or more previous frames. The system 500, in certain examples, determines the dynamic track 504a by predicting the trajectory of each agent over time and space. The system 500 can be configured to determine (e.g., update) the dynamic track 504a at particular time intervals. The dynamic track can be seen as a decomposition of a 3-dimensional path to a 2-dimensional path of the agent, for example having a path length and a lateral clearance length of the agent. The dynamic track, for example, is a two-dimensional indication of a potential path of the agent over time. The dynamic track, in some examples, varies in location based on time. In other words, as the agent moves, the dynamic track of the agent is updated as well.

In one or more examples or embodiments, the system 500 uses the dynamic track for generating obstacle data 502a associated with the agent. System 500 can be configured to generate a plurality of obstacle data 502a, each obstacle data associated with one of a plurality of agents. The system 500, for example, converts the dynamic tracks into obstacles indicated by the obstacle data 502a. The obstacle data, in certain examples, is indicative of the agent being an obstacle along the first trajectory of the autonomous vehicle. For example, if the agent is not an obstacle along the first trajectory, the system 500 is configured to not generate obstacle data associated with the agent. Generating the obstacle data, for example, includes taking as input sensor data 506 to the perception system 502 (e.g., sensor data 506) and converting dynamic tracks from the prediction system 504 into obstacle data 502a by the system 500. In one or more examples or embodiments, the obstacle data 502a provides one or more parameters characterizing the agent as an obstacle to the trajectory of the autonomous vehicle. Parameters include, for example, dimensions (e.g., general dimensions) of the obstacle, e.g., agent. The dimensions may be a generalized set of dimensions, such as a polygon representing the agent. The obstacle data, in some examples, is a simplified data representation of the dynamic track, which can be used to improve computational efficiency.

In one or more examples or embodiments, the system 500 uses the obstacle data 502a for planning of actions to be taken by the autonomous vehicle, such as via planning system 520 (which can be the same or similar as planning system 404 of FIG. 4). Based on the obstacle data 502a, in one or more examples or embodiments, the system 500 is configured to determine different constraints for trajectories of the autonomous vehicle. Constraints can be understood as limitations on the movement of an autonomous vehicle. For example, a constraint would prevent an autonomous vehicle from changing into a lane with another vehicle in it.

As an example, the system 500 uses a constraint generation system 508 for determining one or more constraints 508a to apply to the trajectories of the autonomous vehicle. For example, system 500 is configured to determine, based on the obstacle data, a station constraint 508a and/or a lateral constraint 508a. The station constraint can be seen as a station maneuver description which can be characterized (e.g., parameterized by) in time and space. In other words, the autonomous vehicle is prevented from moving in a certain direction at a certain time via the station constraint. In one or more examples or embodiments, the station constraint is defined by an upper and lower spatial/station bound which the autonomous vehicle should stay within. The station constraint can be seen as a constraint applied to the longitudinal maneuver of the autonomous vehicle. The station constraint is, for example, a spatio-temporal constraint, e.g., station over time. In one or more examples or embodiments, the lateral constraint is a constraint which is characterized (e.g., parameterized by) in space and station. For example, the lateral constraint is a lateral clearance over station. The obstacle data, in some examples, is used to generate constraints, representing where the autonomous vehicle can be along the first trajectory (station) and how much space it has to its sides (lateral) at a specific time within the horizon. The system 500 can be configured to provide data for controlling the speed of the autonomous vehicle and when to stop based on the clearance available along the path that is going to interact with the autonomous vehicle. The constraints can be generated by the constraint generation system 508 included in the planning system 520 (e.g., the same or similar to the planning system 404, 604a of FIGS. 4 and 6, respectively).

In other words, system 500 uses the obstacle data for determining one or more constraints for movement of the autonomous vehicle in time. As the autonomous vehicle should not hit or otherwise interact with the agent trajectory represented by the obstacle data, the obstacle data can be useful for determining actions that an autonomous vehicle should not take. For example, system 500 determines the station constraint 508a for longitudinal motion, such as forward and backward (e.g., reverse) motion of the autonomous vehicle. For example, system 500 determines the lateral constraint 508a for lateral or sideways motion of the autonomous vehicle. The constraints can be dynamically adjusted as needed by the system based on any updates of the obstacle data (such as via an update of the dynamic track). In one or more examples or embodiments, by using the station constraint 508a and the lateral constraint 508a (which limits movement of the autonomous vehicle), system 500 may look forward in time (e.g., a single dimension). This can greatly improve efficiency of analysis for generating the second trajectory. The second trajectory should for example avoid any collisions with any of the obstacles in the environment.

In one or more examples or embodiments, the system 500 is configured to take actions at particular times (e.g., particular time stamps, particular time intervals). The time stamps may be at particular intervals, such as every millisecond, every second, as would be advantageous. For example, the system 500 is configured to one or more of: obtain the sensor data 506, determine the dynamic track 504a, generate the obstacle data 502a, and determine the station constraint 508a and lateral constraint 508a, every time stamp. In one or more examples or embodiments, the system 500 is configured to determine whether there is a differential between the dynamic track and/or the obstacle data of the previous time stamp and the dynamic track and/or the obstacle data of the current time stamp. The system 500 can then be configured to update the station constraint 508a and/or the lateral constraint 508a as needed.

Once the constraints have been determined, the system 500, in some examples, is configured to generate one or more additional trajectories 510b (e.g., via trajectory generation system 510). The one or more additional trajectories 510b can be seen as a second trajectory 510b, third trajectory, etc. In one or more examples or embodiments, the system 500 is configured to generate a second trajectory 510b of the autonomous vehicle based on the station constraint 508a and/or the lateral constraint 508a. The second trajectory 510b is for example a corridor that is free from a collision with one of the obstacles, e.g., agents. In some examples, the second trajectory is the same as the first trajectory. In some examples, the second trajectory is different than the first trajectory. For example, it would be advantageous for the autonomous vehicle to change trajectories if the obstacle data and/or the dynamic track is indicative of the agent interacting with the first trajectory in a manner that it would interact with the autonomous vehicle (e.g., enter in collision with the autonomous vehicle). Optionally, system 500 includes a trajectory selector system 512 which can choose a particular trajectory 512a generated by the trajectory generation system 510. In one or more examples or embodiments, the trajectory generation system 510 generates a single additional trajectory 510b (e.g., second trajectory) and the trajectory selector system 512 is not needed.

In one or more examples or embodiments, providing data associated with the second trajectory configured to cause operation of the autonomous vehicle includes generating control data for a control system 513 of an autonomous vehicle (such as control system 408 of FIG. 4). For example, system 500 is configured to provide the data associated with the second trajectory so that the autonomous vehicle operates along the second trajectory. Providing data configured to cause operation of the autonomous vehicle, in some examples, includes transmitting control data to, e.g., a control system of an autonomous vehicle and/or an external system. In one or more examples or embodiments, the system is configured to control, based on control data, a control system of an autonomous vehicle and/or an external system. The autonomous vehicle discussed herein can be any one of an L0, L1, L2, L3, L4, or L5 level of autonomy, e.g., in the SAE (Society of Automotive Engineers) framework. For example, the autonomous vehicle is a driverless vehicle, such as a fully autonomous vehicle.

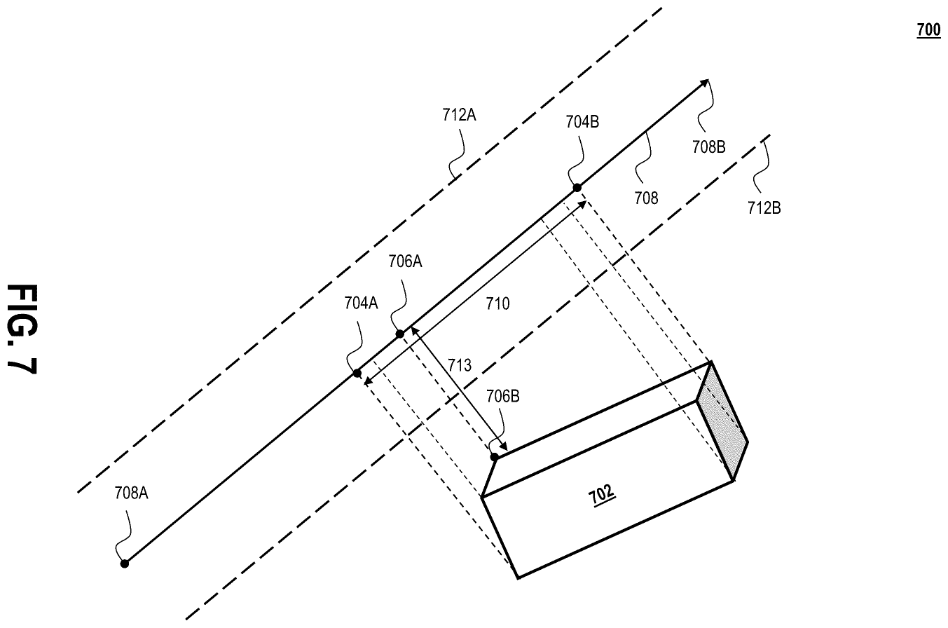

In one or more examples or embodiments, generating the obstacle data includes determining a projected distance of the agent onto the first trajectory. In other words, the system can determine a projected distance between the agent and the path of the autonomous vehicle, as illustrated in FIG. 7. For example, system 500 is configured to determine and/or generate a polygon associated with the agent (e.g., indicative of a shape thereof). In one or more examples or embodiments, the system 500 projects points from the polygon of the agent (e.g., shape) to a baseline path of the first trajectory (e.g., center of the lane forming part of the first trajectory). In situations where the first trajectory is a corridor allowing for some maneuverability of the autonomous vehicle, the baseline path may be a center of such a corridor. A station projection onto the first trajectory provides one or more projected distances. The system 500, in some examples, selects the shortest distance as the projected distance. However, the baseline path is not strictly the path that the autonomous vehicle will take (such as two parallel lanes). Through the projected distance, it is possible to know where the agent is relative to both paths, avoiding decomposition. When the lane is very wide, the system 500 is for example configured to move the baseline path more to the left or right. For example, the baseline path can be moved along the first trajectory. Advantageously, the first trajectory, in some examples is in 2D space.

In one or more examples or embodiments, generating the obstacle data includes generating the obstacle data including one or more of: the projected distance, an agent type associated with the agent, and an environment type associated with the environment. In some examples, the projected distance is the projected distance to the baseline path as illustrated in FIG. 7. In some examples, the projected distance is the projected distance to each obstacle, e.g., to each agent. For example, each agent is associated with a projected distance. In some examples, the projected distance is the projected distance regarding the starting and ending points of the agent projection used to understand how much space such obstacle occupies. In some examples, the projected distance is the projected distance regarding the closest projection point defining the most constraining point of the agent with respect to the baseline projection, which can be used for clearance. In one or more examples or embodiments, the agent type associated with the agent includes one or more of vehicles, pedestrians, and bicyclists.

In one or more examples or embodiments, the environment type includes one or more aspects of the environment that can be relevant for operation of the autonomous vehicle by the system. In some examples, the environment type can include one or more aspects of the environment that can be relevant for selecting a trajectory or constraining the motion of the AV in response to the obstacle data and the corresponding constraints. The environment type, for example, can be indicative of drivable areas and/or urban areas. The environment type is for example indicative of more specific types of environments, such as highways, surface streets, etc. In one or more examples or embodiments, the system 500 is configured to determine an environment type corresponding to an area that the agent is in (e.g., a drivable area, highway, a Pick-Up Drop-Off (PuDo) area). The projection of the system 500, in some examples, captures metadata to generate an environment type. Metadata can include, for example, semantics to the projection of the agent, which direction and/or orientation the agent is in in the environment, etc. In some cases, the metadata can be used to add semantics to a determined station constraint and/or a determined lateral constraint. In some cases, the metadata can be used to modify a station constraint and/or lateral constraint determined based on a dynamic track. In some examples, the metadata may include an agent type for the agent and/or an environment type for the environment in which the AV and the agent operate. In some such examples, the constraint generation system 508 may generate a station constraint and/or a lateral constraint for the agent taking into account the agent type and the environment type. In some other examples, the trajectory generation system 510 and/or trajectory selector system may generate or select a trajectory based at least in part on the agent type, the environment type, or other semantics derived or extracted from the metadata. The system 500, in some examples, is configured to process the agent in different ways. For example, when the agent is in open driving versus a PuDo driving, a different clearance to that agent can be advantageous. For example, in a PuDo scenario, an autonomous vehicle usually drives very slowly, so most of the time, the system 500 can be configured to operate the autonomous vehicle to stay closer to the pedestrian or to the vehicles (e.g., agents). But on a highway, e.g., open driving, system 500 is configured to operate the autonomous vehicle to not stay so close to a pedestrian and/or vehicle. In some cases, metadata can be included, e.g., as semantic information, with a station constraint and/or a lateral constraint to be used for the further processing (e.g., by the trajectory generation system, the trajectory selector system, and/or the control system 513).

In certain examples, the projected distance is used to determine the constraints to the autonomous vehicle. In one or more embodiments or examples, determining the station constraint 508a and the lateral constraint 508a includes determining, based on the projected distance, the station constraint 508a. In one or more examples or embodiments, determining the station constraint 508a and the lateral constraint 508a includes determining, based on the projected distance, the lateral constraint 508a. For example, station projection onto the first trajectory provides one or more projected distances. The system 500, in certain examples, is configured to select the shortest distance as the projected distance to use for determining the station constraint 508a. In other words, the station projection is based on obstacle decision option (e.g., obstacle action or behavior, e.g., where the agent is going), for example if the system 500 determines that the autonomous vehicle should pass after the obstacle, the system 500 is configured to generate a station constraint 508a before the obstacle. For example, the distance of the dynamic track associated with the agent is projected onto one or more part of the first trajectory, e.g., onto one or more transitions of the route plan. In one or more examples or embodiments, there is a lateral homotopy as well, so the system determines that the autonomous vehicle should pass to the left or to the right based on the projection of the left most point or the right most point of the object.

In one or more examples or embodiments, generating, based on the station constraint and the lateral constraint, the second trajectory includes determining, based on the station constraint and the lateral constraint, a homotopy. A homotopy can be seen as a class describing a set of trajectories, having the same start location and a same end location for which there exists a continuous deformation from one to another while remaining within the class. In one or more examples or embodiments, a homotopy is seen as describing a set of constraints, and trajectories are generated from the set of constraints based on their cost functions and/or other parameters. In other words, a homotopy can be seen as a corridor in space and time. In some examples, a homotopy can be seen as one or more constraints applied to potential trajectories of the vehicle. In some examples these constraints are applied in a 2D space, such as in x and y coordinate system. In some examples, these constraints are station constraints and/or lateral constraints (e.g., spatial constraints and/or spatial lateral constraints). In other words, the homotopy can define the scope of potential trajectories taking into account the constraints imposed by any obstacle in the environment (e.g., any object, agent). In one or more examples or embodiments, the trajectory generation system 510 determines, based on the station constraint and the lateral constraint, a homotopy.

In one or more examples or embodiments, generating, based on the station constraint and the lateral constraint, the second trajectory includes generating, based on the homotopy, the second trajectory of the autonomous vehicle. In certain examples, a homotopy includes a set of trajectories, such as a plurality of trajectories. The system can be configured to generate a plurality of homotopies and select one homotopy of the plurality of homotopies to base the second trajectory on. In some examples, the constraint generation system 508 generates the station constraints 508a and/or lateral constraints 508a. In one or more embodiments or examples, the constraint generation system 508 provides the station constraints 508a and/or lateral constraints 508a to the trajectory generation system 510. In one or more examples or embodiments, the trajectory generation system 510 generates, based on the homotopy, the second trajectory 510b of the autonomous vehicle.

In one or more examples or embodiments, the system 500 is configured to generate a trajectory from each homotopy via a control optimization method (e.g., model predictive control). In one or more examples or embodiments, the system 500 (e.g., via the model predictive control) uses the constraints (e.g., station constraint 508a and/or lateral constraint 508a) contained in a given homotopy to determine an optimized trajectory based on specific objective parameters (e.g., dynamically feasible trajectory). In some examples, the system 500 is configured to generate a trajectory (e.g, from trajectory generation system 510) from each of the homotopies, which are then fed into a ranking system (e.g., trajectory selector system 512) to score the trajectories. In some examples, system 500 generates multiple homotopies unique to decisions and/or constraints made for each projected track on a route plan, and each of these homotopies describes a set of constraints. In some examples, the system 500 generates an optimized trajectory from each homotopy, and the end result is multiple trajectories optimized from multiple homotopies which can be selected from in the trajectory selector system 512. For example, as the homotopy is a corridor specifying the space that the vehicle can operate on, there is no guarantee that there is a dynamically feasible (e.g., considering the motion constraints of the vehicle) trajectory within the constraints.

In one or more examples or embodiments, determining the station constraint and the lateral constraint includes determining can be further based on the agent type. For example, the constraint generation system 508 can determine, based on the agent type of the obstacle data, the station constraint 508a and the lateral constraint 508a. In other words, the agent type may be relevant to the constraints determined by the system. For example, the system 500 is configured to determine a different set of constraints when confronted with obstacle data being indicative of a truck as opposed to obstacle data being indicative of a bicycle.

In one or more examples or embodiments, determining the station constraint and the lateral constraint is further based on the environment type. For example, the constraint generation system 508 can determine, based on the environment type of the obstacle data, the station constraint 508a and the lateral constraint 508a. In other words, the environment itself may provide for potential constraints, by the system 500, onto the autonomous vehicle operation. Examples of environment types include one or more types indicative of: a drivable area, a highway, a PuDo, a dirt road, and an urban road. As an example, the system 500 may apply different constraints when the environment type is indicative of a highway as compared to an environment type indicative of a dirt road.

FIGS. 6A-6B are diagrams of an example implementation of a process for obstacle representation, such as performed by a vehicle 602. The vehicle 602 can be an autonomous vehicle and can be controlled by AV compute 640 (which can be the same or similar to AV compute 540 and/or system 500 of FIG. 5). As shown in FIG. 6A, the AV compute 640 of vehicle 602, in some examples, is configured to obtain sensor data 614. The AV compute 640 is, for example, configured to take the above-discussed actions rereferred to with respect to FIG. 5 and, using planning system 604a (which is the same or similar to planning system 520 of FIG. 5 and/or planning system 404 of FIG. 4) to generate and transmit data 616 associated with a second trajectory to a control system 604b (which can be the same or similar to control system 513 of FIG. 5 and/or control system 408 of FIG. 4), such as for operation of vehicle 602. FIG. 6B illustrates a further implementation where the AV compute 640 can transmit control signals 620, such as for controlling operation of the vehicle 602, from the control system 604b to a DBW system 606.

FIG. 7 is a diagram of an example projection 700 of an obstacle onto a path. In other words, FIG. 7 illustrates the generation of obstacle data. FIG. 7 shows an obstacle illustrated as an agent 702. For example, the obstacle can be polygon shaped and projected onto the baseline. Projecting the obstacle (such as, the agent 702) onto the baseline includes projecting the points from the polygon of the agent 702 to baseline 708 illustrating a first trajectory of an AV. In some examples, the baseline 708 is the center of a lane, with upper lane boundary illustrated as 712A and lower lane boundary illustrated as 712B. For example, generating the obstacle data (e.g., the obstacle data 502a of FIG. 5) includes converting dynamic tracks from a perception system (e.g., the perception system 502 of FIG. 5) and prediction system (e.g., the prediction system 504 of FIG. 6) into obstacle data. In one or more examples or embodiments, an agent 702 is an obstacle to the trajectory of the AV. For example, points 708A, 708B are start and end of a lane and/or of a part of a lane, respectively. For example, the AV interacts with the obstacle (e.g., the agent 702) between point 704A and point 704B. In other words, the obstacle is present in the surroundings of the trajectory of the AV between point 704A and point 704B. The distance 710 (e.g., between point 704A and point 704B) is for example the distance in which the AV interacts with the obstacle along the lane. Put differently, points 704A, 704B result from the projections of points of the polygon of the agent corresponding to e.g., a starting and ending points of the polygon (e.g., starting and ending edges of the polygon). For example, points 704A, 704B and the distance 710 generated from such points can be used, by the disclosed system, to determine the size of the agent. In some examples, points 704A, 704B are used to generate station constraints, such as constraints to allow the AV to make decisions (e.g., stop and/or pass after and/or pass before and/or overtake) based on the agent action along the first trajectory of the AV. For example, point 706A is the shortest lateral clearance. In other words, point 706A is the projection of point 706B, which generates the shortest distance to the baseline, such as distance 714. For example, point 706B is the most constraining point of the agent with respect to the baseline, being used to generate spatial clearance constraints. Generating the spatial clearance constraints involves for example projecting the distance (e.g., the shortest distance with respect to the baseline) of the obstacle (e.g., the agent 702) of a dynamic track to parts of the first trajectory, which corresponds to e.g., one or more transitions of the route plan.

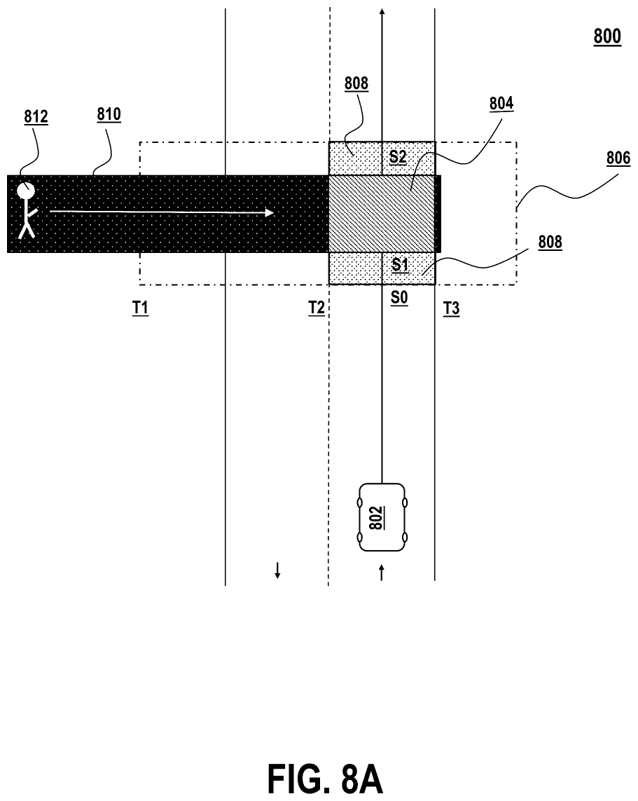

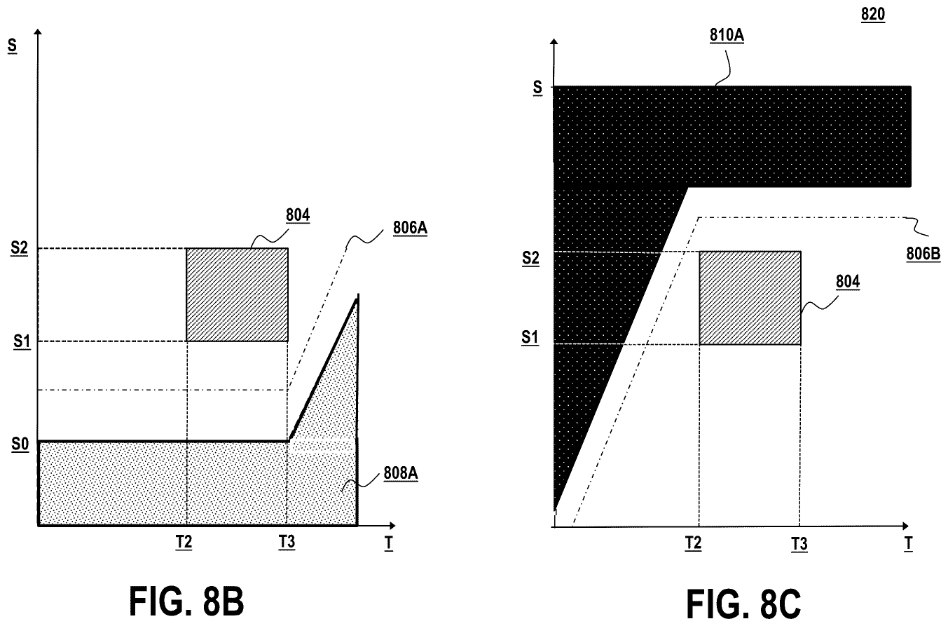

FIGS. 8A-8C are diagrams illustrating example generations 800, 820 of station constraints according to one or more embodiments of this disclosure, e.g., by using system 500. In other words, FIGS. 8A-8C illustrates a generation of station constraints. Specifically, FIG. 8A illustrates a pedestrian 812 (such as, an agent) intending to cross a crosswalk 806, as an autonomous vehicle 802, including system 500, is approaching the crosswalk 806. The autonomous vehicle 802 obtains sensor data (such as, sensor data 506 of FIG. 5) indicative of the pedestrian 812. FIGS. 8B-8C illustrates a Station-Time (S0, S1, S2 denoting respective station locations of the AV also shown in FIGS. 8B-C, T1, T2, T3 denoting various times also shown in FIGS. 8B-C) analysis, such as a station projection, based on an action of the pedestrian 812 and/or prediction thereof. For example, the action of the pedestrian 812 can be the pedestrian 812 crossing the crosswalk 806 either before the autonomous vehicle 802 reaches the cross walk 806 or after the autonomous vehicle 802 moves across the cross walk 806.

FIG. 8B illustrates a Station-Time analysis 820 when the pedestrian 812 crosses the crosswalk 806 before the autonomous vehicle 802 of FIG. 8A reaches the cross walk 806 of FIG. 8A including a boundary 806A. For example, the autonomous vehicle 802 can pass through the crosswalk after the pedestrian crosses the crosswalk by increasing its velocity and/or acceleration. FIG. 8C illustrates a S-T analysis when the pedestrian 812 of FIG. 8A crosses the crosswalk 806 of FIG. 8A after the autonomous vehicle 802 of FIG. 8A moves across the cross walk 806 of FIG. 8A. For example, the autonomous vehicle 802 of FIG. 8A can wait for the pedestrian 812 to cross the crosswalk by decreasing its velocity and/or by stopping before reaching the crosswalk. In some examples, the generation of a spatial constraint is based on an action taken by an obstacle (e.g., an agent), such as pedestrian 812. For example, area 808 of FIG. 8A indicates the area that the autonomous vehicle can occupy when the pedestrian 812 crosses the crosswalk 806 before the autonomous vehicle 802 reaches the cross walk 806. For example, area 810 of FIG. 8A indicates the area that the pedestrian can occupy when the pedestrian 812 crosses the crosswalk 806 after the autonomous vehicle 802 moves across the cross walk 806. Put differently, areas 808, 810 in FIG. 8A are, for example, regions occupied by the pedestrian 812 and/or the autonomous vehicle 802 associated with actions taken by the pedestrian 812, with such actions and regions being used to generate the spatial constraints. In some examples, areas 808A, 810A of FIGS. 8B-8C, respectively, are decision making regions generated after the generation of spatial constraints. In some examples, area 804 of FIGS. 8A-8C depict an area where the pedestrian comes into contact the autonomous vehicle when the pedestrian and the autonomous vehicle decides to pass through cross walk at same time. For example, the crosswalk 806 includes a lower boundary (e.g., illustrated as 806A in FIG. 8B) and an upper boundary (e.g., illustrated as 806B in FIG. 8C). Station S0, with time T2 and T3 of FIG. 8B shows an example illustration when the AV 802 passes after the pedestrian 812 crosses the crosswalk. Stations S1, S2, with time T2 and T3 of FIG. 8C shows an example illustration when the AV 802 passes before the pedestrian 812 crosses the crosswalk.

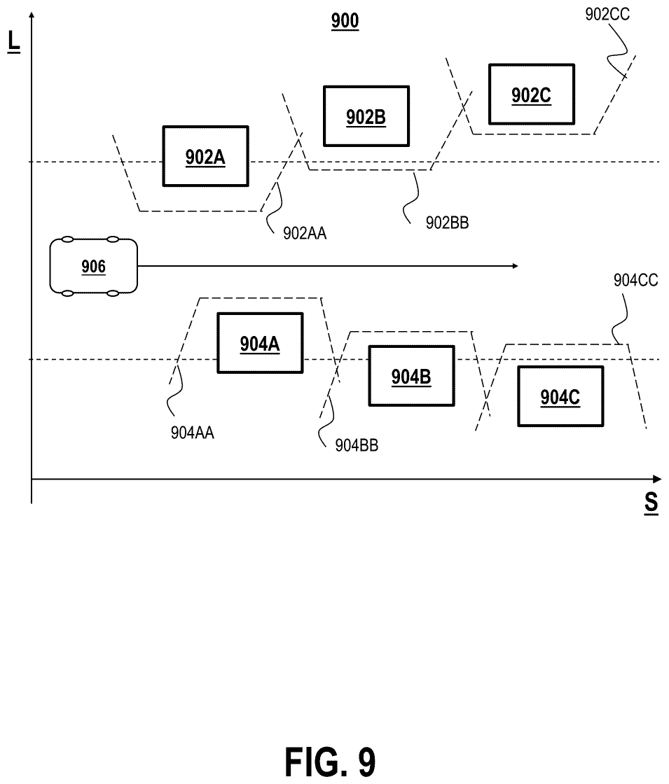

FIG. 9 is a diagram illustrating an example generation 900 of lateral constraints according to one or more embodiments of this disclosure, e.g., by using system 500. In other words, FIG. 9 illustrates a generation of spatial constraints. FIG. 9 illustrates a Station-Lateral Clearance (S-L) analysis. FIG. 9 illustrates an autonomous vehicle 906 moving across a lane, which obtains sensor data (such as, sensor data 506 of FIG. 5) indicative of a first and a second agent (e.g., a vehicle and/or a pedestrian and/or a bicyclist). For example, 902A, 902B, 902C is a first agent (e.g., an obstacle) at T seconds, T+1 seconds and T+2 seconds, respectively. For example, 904A, 904B, 904C is a second agent (e.g., an obstacle) at T seconds, T+1 seconds and T+2 seconds, respectively. In some examples, the autonomous vehicle 906 moves through the lane treating the first and second agents as obstacles. For example, spatial constraints (e.g., spatial constraints 902AA, 902BB, 902CC, 904AA, 904BB, 904CC for the first agent 902A, 902B, 902C and second agent 904A, 904B, 904C, respectively) are generated owing to the interaction of the autonomous vehicle 906 with the first and second agents. For example, the autonomous vehicle is capable of changing direction (e.g., moving to the left or to the right) according to the projection of the obstacles along the baseline path based on their dynamic tracks. In other words, the autonomous vehicle can change direction based on the projection of the left most point or the right most point of the first and second agents as their position changes with respect to the baseline path. For example, the left most point or the right most point of an obstacle is point 706B in FIG. 7, whose projection with respect to the baseline is 706A in FIG. 7. For example, the left most point or the right most point of an obstacle defines the most constraining point of the obstacle (e.g., that produces the shortest lateral clearance distance 712 of FIG. 7 to the projected point 706A of FIG. 7), which is used to define the lateral constraints (e.g., the spatial clearance or lateral constraints 902AA, 902BB, 902CC, 904AA, 904BB, 904CC).

Referring now to FIG. 10, illustrated is a flowchart of a method or process 1000 for determining constraints associated with one or more obstacles (e.g., a dynamic obstacles) and generating a trajectory based on the determined constraints, where the trajectory can be used to operate and/or control an AV in the presence of obstacles. The method can be performed by a system disclosed herein, such as an AV compute 202f of FIG. 2 and AV compute 400 of FIG. 4, a vehicle 102, 200, of FIGS. 1 and 2, respectively, device 300 of FIG. 3, and system 500 and AV compute 540 of FIG. 5 and implementations of FIGS. 6A-6B as well as FIGS. 7-9. The system disclosed can include at least one processor which can be configured to carry out one or more of the operations of method 1000. The method 1000 can be performed (e.g., completely, partially, and/or the like) by another device or group of devices separate from or including system disclosed herein.

In one or more embodiments or examples, the method 1000 includes obtaining, at step 1002, using at least one processor, sensor data. In one or more embodiments or examples, the sensor data is indicative of an agent in an environment where an autonomous vehicle (AV) is configured to operate along a first trajectory (e.g., a baseline path). In some examples, the agent can be an object that can have dynamic behavior in an environment surrounding the AV. In some examples, the sensor data can be indicative of one or more agents, such as one or more of: a vehicle, a pedestrian, and a bicyclist.

In one or more embodiments or examples, the method 1000 includes determining, at step 1004, using the at least one processor, a dynamic track associated with an agent. For example, a dynamic track is a prediction of an agent trajectory as a function of time. For example, the dynamic track keeps track of the agent, e.g., agent trajectory, over time. Prediction is for example to predict where the agent moves based on the velocity of the agent in one or more previous frames (e.g., time frames). Dynamic tracks are, for example, predictions of the trajectory of the agent over time and space.

In one or more embodiments or examples, method 1000 includes generating, at step 1006, using the at least one processor, based on the dynamic track, obstacle data associated with the agent. In one or more embodiments or examples, the obstacle data is indicative of the agent being an obstacle along the first trajectory of the autonomous vehicle. In one or more embodiments or examples, the obstacle data provides one or more parameters characterizing the agent as an obstacle to the trajectory of the AV. Generating the obstacle data includes, for example, converting dynamic tracks from perception system (e.g., sensor data) and prediction system into obstacle data.

In one or more embodiments or examples, the method 1000 includes determining, at step 1008, using the at least one processor, based on the obstacle data, a station constraint and a lateral constraint to apply to trajectories or to generate safe trajectories that do not intercept with the dynamic trajectory of the agent. In one or more embodiments or examples, the station constraint is a station maneuver description which is characterized (e.g., parameterized by) in time and space. The station constraints are for example defined by an upper and lower spatial/station bound of a corridor which the AV should stay within. The station constraints can include a constraint applied to a longitudinal maneuver of the vehicle (e.g., changing velocity along a baseline path). In some examples, the station constraint can be a spatio-temporal constraint, e.g., a time varying station. The lateral constraint can be a constraint associated with lateral distance of an agent with respect to the baseline path. In some cases, the lateral constraint can be characterized in station-lateral (S-L) domain. In some cases, the lateral constraint can be characterized in station-time (S-T) domain by defining a spatio-temporal boundary of the agent. In some examples, the lateral constraint can be a lateral clearance over a station. In some cases, obstacle data is used to generate constraints, representing where the AV can be along the first trajectory (station) and how much space it has to its sides (lateral) at a specific time within the horizon. Actions such as speeding up, slowing down and when to stop can be designed based on the clearance available along a path (such as, a lane) that is going to interact with the AV.

In one or more embodiments or examples, method 1000 includes generating, at step 1010, using the at least one processor, based on the station constraint and the lateral constraint, a second trajectory of the autonomous vehicle. In some examples, the second trajectory can be different from or the same as the first trajectory. The second trajectory is, for example, a corridor. In one or more embodiments or examples, the method 1000 includes providing, at step 1012, using the at least one processor, data associated with the second trajectory. In one or more embodiments or examples, the data associated with the second trajectory is configured to cause operation of the autonomous vehicle along the second trajectory.

In one or more embodiments or examples, generating, at step 1006, the obstacle data includes determining a projection of a representation of an agent onto the first trajectory. For example, the agent can be parameterized as a polygon and generating the obstacle data includes projecting selected points of the polygon (e.g., vertices) to a baseline path of the first trajectory (e.g., center of the lane forming part of the first trajectory), as illustrated in FIG. 7. In one or more embodiments or examples, station projection (e.g., projection of the agent which is polygon shaped) onto the first trajectory provides one or more projected distances. For example, the shortest distance is selected as the projected distance. In some examples, the baseline path is not strictly the path that AV will take (such as, two parallel lanes). Using the projected points, it is possible to determine a trajectory of the agent relative to both paths (such as, the two parallel lanes), without decomposing the trajectory of the agent into time, station, and lateral clearance parameters (e.g., threating obstacle avoidance as a 3D dimension problem). In some cases, generating obstacle data may include determining a distance travelled along the path (such as, the length of the obstacle as illustrated as distance 710 of FIG. 7), based on the projection of the agent. In some examples, generating the constraints (such as, station and lateral constraints) includes generating the constraints within the determined distance travelled along the path distance (instead of a distance associated with the time horizon the AV is configured to operate). In other words, generating the constraints includes generating the constraints for the time interval an agent is detected by the AV. In some examples, the baseline path is the center of the lane. In some other cases, e.g., when a lane is very wide, the baseline path can be closer to a left or right boundary of the lane. In some examples, the trajectory is in 2D space.

In one or more embodiments or examples, generating, at step 1006, the obstacle data includes generating the obstacle data including one or more of: the projected distance, an agent type associated with the agent, and an environment type associated with the environment surrounding the agent and/or the AV. For example, the projected distance can be a distance with respect to the baseline path. In some cases, an agent polygon can be estimated for the agent, where the agent polygon represents a spatial boundary of the agent. In some such cases, the projected distance can be generated by determining a lateral distance of a vertex of the agent polygon from a baseline path associated with the first trajectory. Additionally or alternatively, the projected distance can be generated by a normal projection of a vertex of the agent polygon on a baseline path associated with the first trajectory. A normal projection can include projecting a point (e.g., a vertex of the agent polygon) on the baseline path along a direction normal (perpendicular) to the baseline path.

For example, each obstacle (e.g., each agent) is associated with a plurality of projected distances. For example, the projected distance is the shortest projected distance with respect to the baseline path. A distance (such as, distance 710 of FIG. 7) associated with a starting and an ending point (such as starting and ending points 704A, 704B) of the agent projection is, for example, used to determine the width of the agent (e.g., how much space such agent, such as an obstacle, occupy). A distance associated with the closest projection point with respect to the baseline, for example, defines the most constraining point of the agent and is for example used for lateral clearance. For example, the distance associated with the closest projection point with respect to the baseline is the projected distance.

In some embodiments, metadata may be combined with or attached to a the determined projection of an agent. In some examples, metadata includes agent types and/or environment type. In some examples, the agent type includes vehicles and/or pedestrians and/or bicyclists. In some examples, the environment type corresponds to an area (e.g., a drivable area, highway, PuDo) where the agent is located. In some cases, metadata, which is attached to the projection of the agent, may be used to determine a type of driving behavior taken by the AV. In some examples, metadata may be attached as semantics to the projection of the agent (e.g., projection of an agent into a station-time domain or a station-lateral-time domain). In some examples, the presence of an agent (e.g., an obstacle) near or within different types of environments, can cause processing of the agent (e.g., the projection of the agent) for generating the station and lateral constraints, in a different manner. For example, when the agent is in open driving versus a pickup and drop off (PuDo) driving, a different clearance to that obstacle can be generated. For example, in a PuDo scenario, the AV drives very slow implying that most of the driving time the AV can stay closer to pedestrians, vehicles or bicyclists (e.g., agents). However, on a highway (e.g., open driving), driving close the pedestrians and/or vehicles is not desirable. In some cases, the metadata may be provided to the constraint generation system 508 and can be used for generation of accurate station and lateral constraints. In some examples, metadata appended to the projection of the agent, can be transmitted to other processing systems of the AV for further processing.

In one or more embodiments or examples, determining, at step 1008, the station constraint and the lateral constraint includes determining, based on the projected distance, the station constraint. In one or more embodiments or examples, determining, at step 1008, the station constraint and the lateral constraint includes determining, based on the projected distance, the lateral constraint. For example, projecting the agent (e.g., polygon shaped) with respect to the baseline provides one or more projected distances. For example, station projection onto the first trajectory provides one or more projected distances. In other words, the station projection is based on the agent action (e.g., obstacle decision option) along the first trajectory of the AV. For example, the station constraint allows the AV to make decisions (e.g., stop and/or pass after and/or pass before and/or overtake) based on the agent action along the first trajectory of the AV. For example, when the AV intends to pass a cross walk after the obstacle (e.g., a pedestrian) crosses it, a station constraint is implied to oblige the AV to slow down or even stop (as illustrated in FIG. 7B). For example, the shortest distance is selected as the projected distance to use for determining the lateral constraint. For example, the autonomous vehicle can change direction (e.g., moving to the left or to the right) according to the projection of the obstacles with respect to the baseline along the dynamic track. In other words, the autonomous vehicle can change direction based on the projection of the left most point or the right most point of the obstacles. For example, the left most point or the right most point of an obstacle defines the most constraining point of the obstacle (e.g., that produces the shortest lateral clearance distance 712 of FIG. 7 to the projected point 706A of FIG. 7), which is used to define the spatial clearance constraints.

In one or more embodiments or examples, generating, at step 1010, based on the station constraint and the lateral constraint, the second trajectory includes determining, based on the station constraint and the lateral constraint, a homotopy (e.g., a set of trajectories). In one or more embodiments or examples, generating, at step 1010, based on the station constraint and the lateral constraint, the second trajectory includes generating, based on the homotopy, the second trajectory of the autonomous vehicle.

In one or more embodiments or examples, determining, at step 1008, the station constraint and the lateral constraint is further based on the agent type. In one or more embodiments or examples, determining, at step 1008, the station constraint and the lateral constraint is further based on the environment type.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Disclosed are non-transitory computer readable media comprising instructions stored thereon that, when executed by at least one processor, cause the at least one processor to carry out operations according to one or more of the methods disclosed herein.

### Example Autonomous Vehicle (AV) Compute System

In some cases, an AV compute 540 can be configured to provide trajectories that are used by the control system 513 to avoid a collision or detrimental interaction with an agent in an environment while navigating the AV in the environment. In some cases, the control system 513 can receive commands to move the AV along a baseline path. In some cases, the baseline path can be a path determined based on a starting point and a destination and one or more roads, or streets connecting the starting point to the destination. In some examples, the baseline path can be a center line of a lane or road.

In some cases, the control system can operate the AV along a first trajectory associated with the baseline path. In some cases, the first trajectory can be a trajectory generated by the planning system 520, or an initial trajectory generated by another system of the AV based on the baseline path and certain predetermined constraints (e.g., static constraints) associated with the baseline path (e.g., the boundaries and lanes of a road or certain structures and/or barriers along the road).

In some cases, the perception system 502 can be configured to receive sensor data 506 from a sensor (e.g., a camera or a LiDAR) and use the received sensor data 506 to generate obstacle data 502a indicative of one or more agents that can potentially interact with the AV (e.g., agents near the baseline path). In some cases, these agents can be dynamic and change their positions over time. As such obstacle data can be time dependent and, in some cases, is collected sequentially (e.g., at equal time intervals) to capture the changes in the location and/or velocity of the agents (e.g., with respect to the baseline path).

In some cases, the prediction system 504 can use the obstacle data to predict a dynamic track 504a of an agent. In some examples, dynamic track 504a can be a predicted trajectory of the agent in space and time. In some implementations, the prediction system 504 can extract the dynamic track 504a of an agent from a sequence of frames or data points captured by a sensor (e.g., a camera or a LiDAR of the AV) at consecutive time steps during a measurement time interval. For example, the prediction system 504 can use previously received sensor data to estimate a position, a velocity (e.g., a linear or an angular velocity), and/or a direction of motion (or rotation) of an agent, and subsequently use the estimated position, velocity, and/or direction of motion to determine or predict a future location of the agent at a later time. In some implementations, the prediction system 504 determines the position, velocity, direction of motion, and future location of the agent with respect to the baseline path.

In some implementations, planning system 520 may capture or receive metadata indicative of characteristics of an agent or an environment. In some examples, such metadata can be usable for generating or tailoring constraints generated for avoiding collision or interaction with an agent.

In some cases, the metadata can be generated by the perception system 502 based on sensor data 506. In certain cases, the metadata can be generated based at least in part on data stored in a memory of the planning system 520 or received from another system of the AV. In some examples, the metadata may be generated by comparing the sensor data 506 with reference data stored in a memory of the AV. In some cases, the perception system 502 may generate the metadata and append it to the obstacle data 502a. In various implementations, the metadata can include agent type, environment type, or both. In some cases, the planning system 520 can generate metadata based at least in part on a dynamic track 504a predicted for an agent.

In some cases, the constraint generation system 508 may receive the obstacle data 502a and the dynamic track 504a and generate constraints 508a usable for determining a space-time region occupied by an agent and/or a safe space-time region that the AV can occupy without interacting or colliding with the agent. In some cases, the constraints 508a can be determined with respect to time, a longitudinal direction (e.g., a direction along the baseline path and/or along a direction of motion of the VA), and/or a lateral direction that can be substantially perpendicular to the longitudinal direction and parallel to the ground. In some examples, a longitudinal constraint may indicate a distance between AV and the agent along the baseline path at a specific time and is referred to as station constraint. In some examples, a lateral constraint indicates a lateral distance between the AV and the agent at a specific time. In some examples, the lateral constraint is determined based on the smallest lateral distance between the AV and the agent.

In some cases, the constraint generation system 508 may use a set of generalized parameters to represent the agent and use the generalized parameters to determine the lateral and station constraints. For example, the generalized parameter can include a polygon (also referred to as agent polygon) representing the boundaries of the agent such that avoiding an overlap with the polygon in station-lateral domain prevents interaction or collision with the agent. In some cases, the generalized parameters can be generated by the perception system 502 and can be provided to the constraint generation system 512 (e.g., as part of the obstacle data 502a). In some cases, the station constraint can be generated based on a projection of the polygon on the baseline path. For example, some of the vertices of the polygon may be projected to points along the baseline and those points may be used as station constraints or used to generate the station constraints. In some cases, the constraint generation system 508, can use the projections of two vertices of the polygon that define a longitudinal boundary of the agent, and/or the projection of a third vertex having the shortest lateral distance (e.g., normal lateral distance) from the baseline path, to generate the station and lateral constraints. In some cases, the third vertex may be referred to as the most containing point of the agent.

In some examples, the constraint generation system 508 generates a constraint by determining the constraining boundaries of an agent in station, lateral, and time (S-L-T) domain. In some examples, the constraint generation system 508 generates a constraint by determining the constraining boundaries of an agent in station and time (S-T) domain based at least in part on a determined lateral constraint. In some cases, the constraint generation system 508 generates a corridor in station and lateral domain (S-L) domain. In some cases, given the dynamic nature of an agent the corridor in the S-L domain can be time dependent. In some cases, a time-dependent corridor may be used to generate the constraining boundaries of an agent in the S-T domain. It should be understood that the constraining boundaries of an agent in S-L-T domain can be larger than actual physical boundaries of the agent as the constraint generation system 508 can determine a larger boundary based on safety requirements, limitations of the AV, and/or eth corresponding metadata.

In some cases, the constraint generation system 508 may generate the station and lateral constrains based at least in part metadata associated with obstacle data 502a. In some cases, the metadata can be attached to the obstacle data 502a and received from the perception system 502. In some examples, the constraint generation system 508 may generate the station and lateral constraints for an agent based on the agent type and/or an environment surrounding the agent. In some cases, the agent type and/or the environment type may affect determination of the constraining boundaries of the agent in space-time.

In some implementations, once the constraining boundaries of an agent are determined in space-time domain (e.g., station-time domain), the trajectory generation system 510 may generate a safe space-time region based on the determined constraining boundaries of the agent in the spacetime domain. In some cases, the trajectory generation system 510 may generate a safe space-time region based on the station constraints and the lateral constraints received from the constraint generation system 508. The safe space-time region can be a region in the S-T domain (a region in a station-time map) that can be occupied by the AV. Additionally, in some cases, the trajectory generation system 510 may generate a safe space-time region based on the metadata (e.g., received from constraint generation system 508). Next the trajectory generation system 510 can generate one or more trajectories (e.g., safe trajectories) passing through the safe space-time region. A safe trajectory can be a spatio-temporal trajectory for the AV that does not intercept the spatio-temporal trajectory of an agent.

In some cases, projecting selected points of parametrized dynamic agent (e.g., vertices of any agent polygon) along the baseline path and determining lateral distances from the baseline path may be referred to as projecting an agent into station-lateral-time (S-L-T) domain. In some cases, generating the constraints (e.g., the lateral and station constraints) may include an analysis of the projection of an agent station-lateral-time (S-L-T) domain. In some implementations, such analysis may be broken down into an analysis in station-lateral (S-L) domain and using the outcomes in a station-time domain (S-T) analysis for generating the projection of the agent in the (S-L-T) domain. In these cases, the lateral constraint may be embedded in the station-time domain (S-T) as a constraining boundary of the agent projection. In some embodiments, the outcome of projecting the agent in the (S-L-T) domain can be an S-T map including an agent S-T region corresponding to the constraining boundary and a safe S-T region available for the AV to navigate. In some cases, the agent S-T region may be determined based at least in part on metadata (e.g., the agent type and/or environment type). In some cases, the trajectory generation system 510 generates a homotopy based on the safe S-T region and the trajectory selector system 512 selects a trajectory (e.g., a safe trajectory) based on the homotopy and provides the selected trajectory to the control system 513 for navigating the AV along the trajectory.

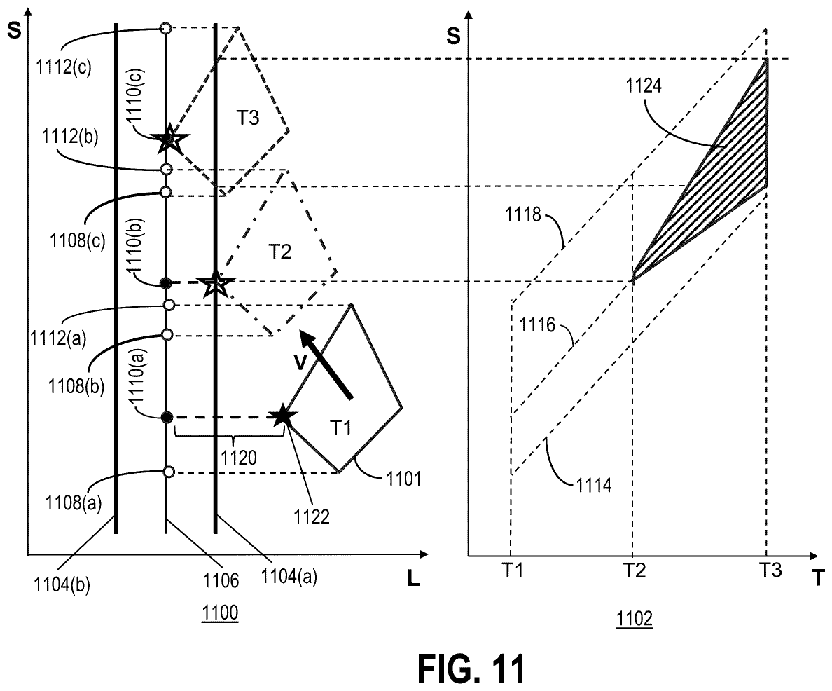

FIG. 11 illustrates an example station-lateral constraint and station time constraint analysis based on sensor data associated with an agent that is moving toward a road along which the AV is moving. As shown in the S-L map 1100, the road is defined by two road border 1104(a) and road border 1104(b) and the AV is originally moving along a baseline path 1106 (e.g., the center line of the road defined by the borders 1104(a) and 1104(b). The agent is represented as an agent polygon 1101 that defines the spatial boundary of the agent. As indicated by the velocity vector (v) of the agent, the agent (and thereby the agent polygon 1101) is moves along the longitudinal direction (the station direction, S) as its lateral distance (e.g., normal lateral distance) to the baseline path 1106 decreases. The S-L map 1100 depicts the positions of the agent polygon 1101 at three different times T1, T2, and T3 along with the projections (e.g., normal projections) of the three vertices of the agent polygon 1101 on the baseline path 1106. Two vertices define the projected length of the polygon agent and the third vertex 1122 located between the first and second vertices, is the most constraining vertex having the closest lateral distance 1120 to the baseline path 1106. In some cases, the lateral position of the third vertex 1122 may be used for generating station constraints and lateral constraints, and the first and the second vertices may further limit the motion of the AV along the longitudinal direction (along station direction). In the example shown, the first vertex is projected on the baseline path 1106 as points 1108(a), 1108(b), and 1108(c), at times T1, T2, and T3 respectively and the second vertex is projected on the baseline path 1106 as points 1112(a), 1112(b), and 1112(c), at times T1, T2, and T3 respectively. Similarly, the third vertex 1122 is projected on the baseline path 1106 as points 1110(a), 1110(b), and 1110(c), at times T1, T2, and T3 respectively. As such, the two-dimensional motion of the agent is reduced to one-dimensional motion of the projected points 1108(a), 1110(a), and 1112(a) along the baseline path 1106. In some cases, the motion of one or more of these projected points may be used to generate the station constraints and the corresponding lateral distances may be used to generate the lateral constraints. The S-L map 1100 and the corresponding analysis can be used to generate a corresponding S-T map for generating safe trajectories (e.g., a safe homotopy) for the AV. In some cases, a safe trajectory can be a trajectory that does not intercept the trajectory of the agent at any point in time. The longitudinal positions of the projected vertices of the agent polygon 1101 can be represented as the traces 1114, 1116, and 1118 on the S-T map 1102 (in this example it has been assumed that the speed of the corresponding agent is constant).

In some cases, the constraint generation system 508 can determine an agent region on the S-T map 1102 based on: the evolution of the lateral position of the agent polygon, a criterion for constraint generation, and in some cases, the metadata associated with the corresponding agent and/or the environment. In some cases, the criterion for constraint generation can include the shortest lateral distance of the agent polygon 1101 from the baseline path 1106. For example, when a lateral distance (e.g., the normal lateral distance) 1120 of the most constraining vertex 1122 to the baseline path 1106 becomes smaller than a first threshold value, the AV should slow down, and when the lateral distance 1120 becomes smaller than a second threshold value, smaller than a first threshold value, the AV should stop to avoid collision with the agent. As another example, a constraint on the motion of the AV can be imposed based on a portion of the agent polygon 1101 that overlaps with the road. In some examples, the overlapping portion can be quantified as the distance between the intercepts where the agent polygon crosses the right border 1104(a) of the road. Accordingly, a constraining agent region 1124 on S-T map may be defined such that the AV stops at the first longitudinal location where the agent polygon 1101 is extended beyond the right road border 1104(a).

In some cases, a constraining agent region can extend beyond the constraining agent region 1124 that depicts a spatio-temporal region associated with a containing criterion. In some examples, constraining agent region may be extended beyond spatio-temporal region associated with a containing criterion based on a speed at which the agent is moving toward the baseline path, various safety measures, or metadata, among other parameters and factors. As such, a constraining agent region (such as the constraining agent region 1124) on the S-T map 1102 can capture certain aspects of both station constraints and lateral constraints. Accordingly, the S-T map 1102 can be used by the trajectory generation system 510 to generate safe trajectories for the AV. In some examples, a safe trajectory with respect to the S-T map 1102 can be a space-time trajectory that does not intercept the constraining agent region 1124. The safe trajectories may constitute a homotopy and the trajectory selector system 512 may use additional criteria (including those associated with metadata), to select a preferred safe trajectory from the homotopy and provide it to the control system 513 and cause the AV to adjust its trajectory from first trajectory to the preferred trajectory to avoid any interaction with the agent. In various implementations, a safe trajectory can be a trajectory in space-time (e.g., station-time) domain. Accordingly, controlling the AV based on the preferred safe trajectory may include, among other actions, slowing down, accelerating, stopping, and/or changing a lateral position with respect or the road borders 1104(a) and 1104(b).

### Example Embodiments

Example embodiments described herein have several features, no single one of which is indispensable or solely responsible for their desirable attributes. A variety of example systems and methods are provided below.

Also disclosed are methods, non-transitory computer readable media, and systems according to any of the following items:
Example 1. A method comprising:
obtaining, using at least one processor, sensor data indicative of an agent in an environment where an autonomous vehicle is configured to operate along a first trajectory;
determining, using the at least one processor, a dynamic track associated with the agent;
generating, using the at least one processor obstacle data associated with the agent based on the dynamic track, wherein the obstacle data is indicative of the agent being an obstacle along the first trajectory of the autonomous vehicle;
determining, using the at least one processor a station constraint and a lateral constraint based on the obstacle data to apply to trajectories;
generating, using the at least one processor a second trajectory of the autonomous vehicle based on the station constraint and the lateral constraint; and providing, using the at least one processor, data associated with the second trajectory, the data associated with the second trajectory configured to cause operation of the autonomous vehicle along the second trajectory.
   Example 2. The method of Example 1, wherein generating the obstacle data comprises determining a projected distance of the agent onto the first trajectory.
   Example 3. The method of Example 2, wherein generating the obstacle data comprises generating the obstacle data comprising one or more of: the projected distance, an agent type associated with the agent, and an environment type associated with the environment.
   Example 4. The method of any of Examples 2-3, wherein determining the station constraint and the lateral constraint comprises determining the station constraint based on the projected distance.
   Example 5. The method of any of Examples 2-4, wherein determining the station constraint and the lateral constraint comprises determining the lateral constraint based on the projected distance.
   Example 6. The method of any of the previous Examples, wherein generating the second trajectory based on the station constraint and the lateral constraint comprises: determining a homotopy based on the station constraint and the lateral constraint; and generating the second trajectory of the autonomous vehicle based on the homotopy.
   Example 7. The method of any of Examples 3-6, wherein determining the station constraint and the lateral constraint comprises is further based on the agent type.
   Example 8. The method of any of Examples 3-7, wherein determining the station constraint and the lateral constraint is further based on the environment type.
   Example 9. A system comprising:
at least one processor; and
at least one memory storing instructions thereon that, when executed by the at least one processor, cause the at least one processor to perform operations comprising: obtaining sensor data indicative of an agent in an environment where an autonomous vehicle is configured to operate along a first trajectory;
determining a dynamic track associated with the agent;
generating obstacle data associated with the agent based on the dynamic track,
wherein the obstacle data is indicative of the agent being an obstacle along the first trajectory of the autonomous vehicle;
determining a station constraint and a lateral constraint based on the obstacle data to apply to trajectories;
generating a second trajectory of the autonomous vehicle based on the station constraint and the lateral constraint; and
providing data associated with the second trajectory, the data associated with the second trajectory configured to cause operation of the autonomous vehicle along the second trajectory.
   Example 10. The system of Example 9, wherein generating the obstacle data comprises determining a projected distance of the agent onto the first trajectory.
   Example 11. The system of Example 10, wherein generating the obstacle data comprises generating the obstacle data comprising one or more of: the projected distance, an agent type associated with the agent, and an environment type associated with the environment.
   Example 12. The system of any of Examples 10-11, wherein determining the station constraint and the lateral constraint comprises determining the station constraint based on the projected distance.
   Example 13. The system of any of Examples 10-12, wherein determining the station constraint and the lateral constraint comprises determining the lateral constraint based on the projected distance.
   Example 14. The system of any of Examples 9-13, wherein generating the second trajectory based on the station constraint and the lateral constraint, comprises: determining a homotopy based on the station constraint and the lateral constraint; and generating the second trajectory of the autonomous vehicle based on the homotopy.
   Example 15. The system of any of Examples 11-14, wherein determining the station constraint and the lateral constraint is further based on the agent type.
   Example 16. The system of any of Examples 11-15, wherein determining the station constraint and the lateral constraint is further based on the environment type.
   Example 17. A non-transitory computer readable medium comprising instructions stored thereon that, when executed by at least one processor, cause the at least one processor to carry out operations comprising:
obtaining sensor data indicative of an agent in an environment where an autonomous vehicle is configured to operate along a first trajectory;
determining a dynamic track associated with the agent;
generating obstacle data associated with the agent based on the dynamic track,
wherein the obstacle data is indicative of the agent being an obstacle along the first trajectory of the autonomous vehicle;
determining a station constraint and a lateral constraint based on the obstacle data to apply to trajectories;
generating a second trajectory of the autonomous vehicle based on the station constraint and the lateral constraint; and
providing data associated with the second trajectory, the data associated with the second trajectory configured to cause operation of the autonomous vehicle along the second trajectory.
   Example 18. The non-transitory computer readable medium of Example 17, wherein generating the obstacle data comprises determining a projected distance of the agent onto the first trajectory.
   Example 19. The non-transitory computer readable medium of Example 18, wherein generating the obstacle data comprises generating the obstacle data comprising one or more of: the projected distance, an agent type associated with the agent, and an environment type associated with the environment.
   Example 20. The non-transitory computer readable medium of any of Examples 18-19, wherein determining the station constraint and the lateral constraint comprises determining the station constraint based on the projected distance.
   Example 21. The non-transitory computer readable medium of any of Examples 18-20, wherein determining the station constraint and the lateral constraint comprises determining the lateral constraint based on the projected distance.
   Example 22. The non-transitory computer readable medium of any of Examples 17-21, wherein generating the second trajectory based on the station constraint and the lateral constraint, comprises:
determining a homotopy based on the station constraint and the lateral constraint; and generating the second trajectory of the autonomous vehicle based on the homotopy.
   Example 23. The non-transitory computer readable medium of any of Examples 19-22, wherein determining the station constraint and the lateral constraint is further based on the agent type.
   Example 24. The non-transitory computer readable medium of any of Examples 19-23, wherein determining the station constraint and the lateral constraint is further based on the environment type.
   Example 25. The method of Example 2, wherein determining the projected distance comprises determining an agent polygon associated with the agent, wherein the agent polygon represents a spatial boundary of the agent.
   Example 26. The method of Example 25, wherein determining the projected distance comprises determining a lateral distance of a vertex of the agent polygon from a baseline path associated with the first trajectory.
   Example 27. The method of Example 25, determining the projected distance comprises determining a normal projection of a vertex of the agent polygon on a baseline path associated with the first trajectory.
   Example 28. The system of Example 9, wherein determining a projected distance comprises determining a lateral distance of the agent from a baseline path or a projected length of the agent on the baseline path, wherein the baseline path is associated with the first trajectory.

What is claimed is:

1. A method comprising:
obtaining, using at least one processor, sensor data indicative of an agent in an environment where an autonomous vehicle is configured to operate along a first trajectory;
determining, using the at least one processor, a dynamic track associated with the agent;
generating, using the at least one processor, obstacle data associated with the agent based on the dynamic track, wherein the obstacle data is indicative of the agent being an obstacle along the first trajectory of the autonomous vehicle;
determining, using the at least one processor, a station constraint and a lateral constraint based on the obstacle data usable for generating trajectories for the autonomous vehicle;
generating, using the at least one processor, a second trajectory of the autonomous vehicle based on the station constraint and the lateral constraint; and
providing, using the at least one processor, data associated with the second trajectory, the data associated with the second trajectory configured to cause operation of the autonomous vehicle along the second trajectory.

2. The method of claim 1, wherein generating the obstacle data comprises determining a projected distance of the agent onto the first trajectory.

3. The method of claim 2, wherein determining the projected distance comprises determining an agent polygon associated with the agent, wherein the agent polygon represents a spatial boundary of the agent.

4. The method of claim 3, wherein determining the projected distance comprises determining a lateral distance of a vertex of the agent polygon from a baseline path associated with the first trajectory.

5. The method of claim 3, determining the projected distance comprises determining a normal projection of a vertex of the agent polygon on a baseline path associated with the first trajectory.

6. The method of claim 2, wherein generating the obstacle data comprises generating the obstacle data comprising one or more of: the projected distance, an agent type associated with the agent, and an environment type associated with the environment.

7. The method of claim 2, wherein determining the station constraint and lateral constraint comprises determining the station constraint and lateral constraint based on the projected distance.

8. The method of claim 2, wherein generating the second trajectory based on the station constraint and the lateral constraint, comprises:
determining, a homotopy based on the station constraint and the lateral constraint; and
generating, the second trajectory of the autonomous vehicle based on the homotopy.

9. The method of claim 6, wherein determining the station constraint and lateral constraint is further based on the agent type or environment type.

10. A system comprising:
at least one processor; and
at least one memory storing instructions thereon that, when executed by the at least one processor, cause the at least one processor to perform operations comprising:
obtaining sensor data indicative of an agent in an environment where an autonomous vehicle is configured to operate along a first trajectory;
determining a dynamic track associated with the agent;
generating, obstacle data associated with the agent based on the dynamic track, wherein the obstacle data is indicative of the agent being an obstacle along the first trajectory of the autonomous vehicle;
determining, a station constraint and a lateral constraint based on the obstacle data to apply to trajectories;
generating, a second trajectory of the autonomous vehicle based on the station constraint and the lateral constraint; and
providing data associated with the second trajectory, the data associated with the second trajectory configured to cause operation of the autonomous vehicle along the second trajectory.

11. The system of claim 10, wherein generating the obstacle data comprises determining a projected distance of the agent onto the first trajectory.

12. The system of claim 11, wherein determining a projected distance comprises determining a lateral distance of the agent from a baseline path or a projected length of the agent on the baseline path, wherein the baseline path is associated with the first trajectory.

13. The system of claim 11, wherein generating the obstacle data comprises generating the obstacle data comprising one or more of: the projected distance, an agent type associated with the agent, and an environment type associated with the environment.

14. The system of claim 11, wherein determining the station constraint and the lateral constraint comprises determining the station constraint based on the projected distance.

15. The system of claim 10, wherein generating the second trajectory based on the station constraint and the lateral constraint, comprises:
determining a homotopy based on the station constraint and the lateral constraint; and
generating the second trajectory of the autonomous vehicle based on the homotopy.

16. The system of claim 13, wherein determining the station constraint and the lateral constraint is further based on the agent type or the environment type.

17. A non-transitory computer readable medium comprising instructions stored thereon that, when executed by at least one processor, cause the at least one processor to carry out operations comprising:
obtaining sensor data indicative of an agent in an environment where an autonomous vehicle is configured to operate along a first trajectory;
determining a dynamic track associated with the agent;
generating obstacle data associated with the agent based on the dynamic track, wherein the obstacle data is indicative of the agent being an obstacle along the first trajectory of the autonomous vehicle;
determining a station constraint and a lateral constraint based on the obstacle data to apply to trajectories;
generating a second trajectory of the autonomous vehicle based on the station constraint and the lateral constraint; and
providing data associated with the second trajectory, the data associated with the second trajectory configured to cause operation of the autonomous vehicle along the second trajectory.

18. The non-transitory computer readable medium of claim 17, wherein generating the obstacle data comprises determining a projected distance of the agent onto the first trajectory.

19. The non-transitory computer readable medium of claim 18, wherein generating the obstacle data comprises generating the obstacle data comprising one or more of: the projected distance, an agent type associated with the agent, and an environment type associated with the environment.

20. The non-transitory computer readable medium of claim 18, wherein determining the station constraint and the lateral constraint comprises determining the station constraint based on the projected distance.
